(19) United States
(12) Patent Application Publication
(10) Pub. No.: US 2019/0299310 A1
(43) Pub. Date: Oct. 3, 2019

(54) Contact Detection Based On Frequency In Ultrasonics

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 16/269,001

(22) Filed: Feb. 6, 2019

Related U.S. Application Data
(60) Provisional application No. 62/650,346, filed on Mar. 30, 2018.

(51) Int. Cl. B23H 7/38; G01N 29/036; B06B 1/02

(52) U.S. Cl. CPC B23H 7/38; B06B 1/0269; G01N 29/036

(57) ABSTRACT

Ultrasonic stack contact with an object is detected upon the determination that the frequency of the ultrasonic stack has changed from the frequency of that ultrasonic stack operating near resonance in air.

### CROSS-REFERENCE TO RELATED APPLICATIONS

This application claims the benefit of U.S. Provisional Application No. 62/650,346 filed on Mar. 30, 2018. The entire disclosure of the above application is incorporated herein by reference.

### FIELD

The present disclosure relates to ultrasonic devices, and more particularly, to contact detection based on frequency.

### BACKGROUND

This section provides background information related to the present disclosure which is not necessarily prior art.

Certain ultrasonic devices have an ultrasonic stack excited by a power supply, which is often also used to control the ultrasonic device. An ultrasonic stack includes an ultrasonic converter and any component ultrasonically coupled to the ultrasonic converter, typically a booster and an ultrasonic horn. The ultrasonic stack vibrates at an ultrasonic frequency and does the actual work on the parts or liquid. The ultrasonic frequency at which the ultrasonic stack is vibrating will be referred to herein as the frequency of the ultrasonic stack. Examples of applications for ultrasonic systems include but are not limited to plastics welding, metal welding, cutting, swaging, marking, staking, cell disruption, cleaning, and liquid agitation. Some ultrasonic systems where parts are worked on further include an actuator. In such embodiments, the actuator moves the ultrasonic stack relative to said parts to be worked on. Some ultrasonic systems where parts are worked on further include an anvil or nest to hold the parts to be worked on.

FIG. 1 shows a model of an ultrasonic stack 102 and power supply 104 of an example of a known type of ultrasonic device 100. It should be understood that ultrasonic device 100 can be any type of ultrasonic device that has an ultrasonic stack excited by a power supply. Typical components of ultrasonic stack 102 include an ultrasonic converter 106, a booster 108 and an ultrasonic horn 110. It should be appreciated that not every ultrasonic stack 102 includes booster 108. It should be further appreciated that not every ultrasonic stack 102 includes ultrasonic horn 110. Ultrasonic horn 110 will often have one or more ultrasonic horn tips (not shown). Booster 108 and ultrasonic horn 110 are ultrasonically connected (directly or via another component) to ultrasonic converter 106. In the example of FIG. 1, booster 108 is mounted to ultrasonic converter 106 ultrasonically connecting booster 108 to ultrasonic converter 106, and ultrasonic horn 110 is mounted to booster 108 ultrasonically connecting ultrasonic horn 110 to booster 108, and thus ultrasonically connecting ultrasonic horn 110 to ultrasonic converter 106 via booster 108. It should be understood that ultrasonic converters are also known in the art as ultrasonic transducers and these terms are used interchangeably. Power supply 104 is controlled by a controller 114 that includes memory 116. It should be understood that controller 114 can be included in power supply 104 or separate from power supply 104. Ultrasonic device 100 will often include an anvil 122 on which a work piece to be processed will be supported and contacted by ultrasonic horn tip 112 when it is being processed. For example, if two metal or plastic parts 124 are being welded together, they are supported on anvil 122 and pressed together by the ultrasonic horn tip during the weld process as an actuator 120 moves ultrasonic stack 102 relative to the two parts 124 where the horn tip also ultrasonically vibrates against one of the parts to ultrasonically weld the two parts 124 together.

It is often desirable to detect when an ultrasonic stack makes contact with the parts to be ultrasonically acted on, makes contact with liquid, or makes contact with the anvil. Prior art methods detect such contact with force detectors in the actuator such as plungers, load cells, or S-beams. Such force detectors, however, require that a relatively high contact force accumulate before registering that a contact had been made. For applications requiring contact forces lower than the contact force necessary for the prior art force detectors to even detect contact, such as welding applications with small and/or delicate parts, prior art force detectors offer no benefit. Yet another disadvantage of such force detectors is that virtually no force accumulates upon making contact with a liquid; such force detectors are therefore essentially futile at detecting contact with a liquid.

### SUMMARY

This section provides a general summary of the disclosure, and is not a comprehensive disclosure of its full scope or all of its features.

In accordance with an aspect of the present disclosure, a method of detecting contact between an ultrasonic stack and an object is disclosed. The method includes moving an ultrasonic stack ultrasonically vibrating near resonance and the object toward each other and determining the ultrasonic stack has made contact with the object based on detecting that a frequency of the ultrasonic stack has changed. In accordance with several aspects, determining that the ultrasonic stack has made contact with an object correlates to contact with an anvil, a liquid to be ultrasonically acted upon, or a workpiece to be ultrasonically acted upon. In accordance with an aspect, the speed at which the actuator is moving the ultrasonic stack and object toward each other is altered in response to detecting the change in frequency. In accordance with an aspect, the ultrasonic power supplied to the ultrasonic stack is altered in response to detecting the change in frequency. In accordance with an aspect, the force at which the actuator is moving the ultrasonic stack and object toward each other is altered in response to detecting the change in frequency.

In accordance with another aspect, an initial ultrasonic cycle of an ultrasonic application is run in which an ultrasonic stack ultrasonically vibrating near resonance and an object are moved toward each other. When a frequency of the ultrasonic stack is detected as having changed, a location of the ultrasonic stack relative to the object at which this change in frequency was detected is stored in a memory of a controller for use with subsequent ultrasonic cycles of the ultrasonic application. In accordance with an aspect, when running a subsequent ultrasonic cycle, the speed at which an actuator moves the ultrasonic stack and object toward each other is altered when the location of the ultrasonic stack relative to the object is at the location at which the change in frequency was detected in the initially run ultrasonic cycle. In accordance with an aspect, when running a subsequent ultrasonic cycle, the ultrasonic power supplied to the ultrasonic stack is altered when the location of the ultrasonic stack relative to the object is at the location is at the location at which the change in frequency was detected in the initially run ultrasonic cycle. In accordance with an aspect, when running a subsequent ultrasonic cycle, a force at which the actuator moves the ultrasonic stack and object toward each other is altered when the location of the ultrasonic stack relative to the object is at the location at which the change in frequency was detected in the initially run ultrasonic cycle.

In accordance with another aspect of the present disclosure, an ultrasonic system in which contact between an ultrasonic stack and an object is detected is disclosed. The ultrasonic system is comprised of an ultrasonic stack that delivers ultrasonic energy to an object; an actuator for moving the ultrasonic stack and object toward each other; a frequency detector for detecting a change in frequency of the ultrasonic stack that is indicative of the ultrasonic stack contacting the object; a power supply in electrical communication with the actuator, the ultrasonic stack, and the frequency detector; and a controller in electrical communication with the frequency detector. The controller is configured to control the actuator. In accordance with an aspect, the object is one of an anvil, a liquid, or a workpiece to be ultrasonically acted upon. In accordance with an aspect, the controller is configured to alter the speed at which the actuator moves the ultrasonic stack and object toward each other in response to the frequency detector detecting the change in frequency. In accordance with an aspect, the controller is configured to control the power supply and the controller is configured to alter the power the power supply provides to the ultrasonic stack in response to the frequency detector detecting the change in frequency. In accordance with an aspect, the controller is configured to alter a force at which the actuator moves the ultrasonic stack and the object toward each other.

In accordance with an aspect, the frequency detector is a detector that senses ultrasonic motion of the ultrasonic stack. In accordance with an aspect, the frequency detector is a detector that electrically senses the frequency of the voltage or current supplied to the ultrasonic stack from the power supply.

In accordance with an aspect, the actuator moves the ultrasonic stack toward the object. In accordance with an aspect, the actuator moves the object toward the ultrasonic stack. In accordance with an aspect, the actuator moves both the ultrasonic stack and the object toward each other.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified diagram of a known type of ultrasonic device;

FIG. 2 is a simplified diagram showing the oscillation of an ultrasonic stack at around resonance;

FIG. 3 is a simplified diagram showing the effective spring constant of an ultrasonic stack upon initial contact of a part to be worked on;

FIG. 4 is a simplified diagram showing the effective spring constant of an ultrasonic stack upon initial contact of a liquid;

FIG. 5 is a flow chart of a control routine for the above described method of detecting when the ultrasonic stack of the ultrasonic device makes contact with an object;

FIG. 6 is a flow chart of a control routine for the above described method of detecting when the ultrasonic stack of the ultrasonic device makes contact with an object for future use; and

FIG. 7 is a flow chart of a control routine in accordance with an aspect of the present disclosure in which the location of the ultrasonic stack relative to the object to be contacted is used in a subsequent ultrasonic cycle.

Corresponding reference numerals indicate corresponding parts throughout the several views of the drawings.

### DETAILED DESCRIPTION

Example embodiments will now be described more fully with reference to the accompanying drawings.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

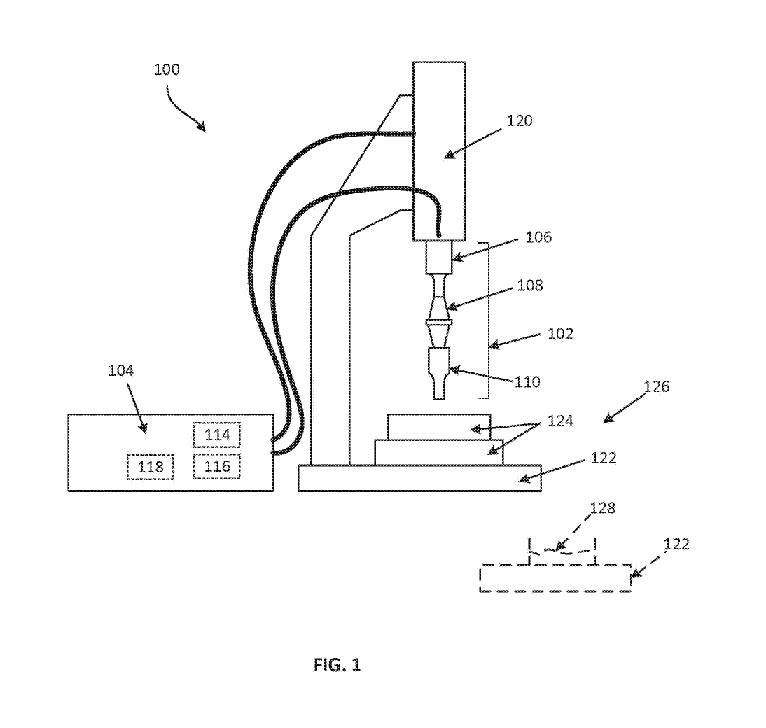

The following discussion will be with reference to ultrasonic device 100 of FIG. 1, but it should be understood that the following applies to any ultrasonic device that has an ultrasonic stack excited by a power supply. In this regard, it should be understood that the method of detecting contact in accordance with an aspect of the present disclosure as described below differs from methods used in prior art ultrasonic devices and the indication that FIG. 1 is prior art does not mean that the below described method is in the prior art. Further, as noted above, ultrasonic stack 102 may or may not comprise either or both of booster 108 or ultrasonic horn 110.

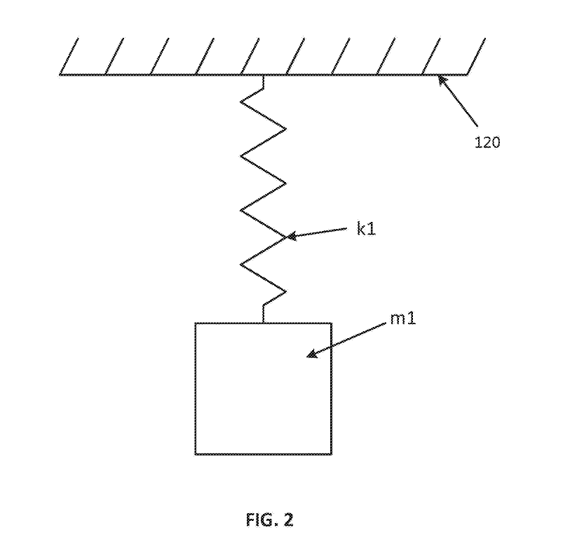

In accordance with an aspect of the present disclosure, a change in frequency is sensed to detect whether an ultrasonic stack has contacted a physical object (e.g., parts to be worked on, an anvil, or a liquid). It should be understood that as used herein, the frequency of the ultrasonic stack is the frequency at which the ultrasonic stack is oscillating. In operation at most frequencies, an ultrasonic stack does not exhibit characteristics of a simple oscillator. Referring to FIG. 2, at about resonance, however, an ultrasonic stack does act like a simple oscillator. The frequency of an ultrasonic stack near resonance is determinable as follows:

$$f = \frac{1}{2 * π} * \sqrt{\frac{{k}_{1}}{{m}_{1}}} \qquad ( 1 )$$

where:
f=frequency
k₁=effective spring constant of oscillator
m₁=effective mass of oscillator.

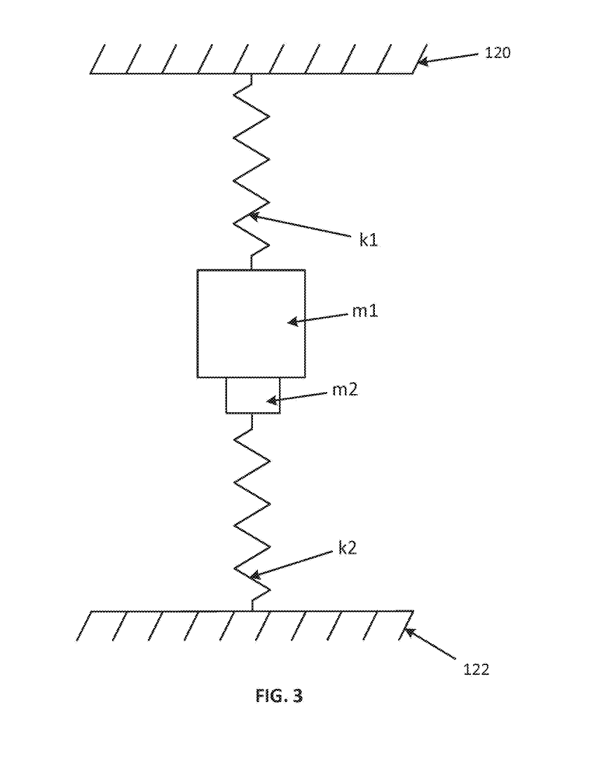

When an oscillator, such as an oscillating ultrasonic stack, makes contact with a solid, the solid is not completely rigid. In fact, the solid exhibits a spring constant. Upon contact, the effective spring constant of the solid adds to the effective spring constant of the oscillator (e.g., the oscillating ultrasonic stack). Referring to FIG. 3, a portion of mass of the solid begins to ultrasonically oscillate, but at initial contact, very little of the mass moves. This contact changes the frequency, which can be calculated as follows:

$${f}_{ContactSolid} = \frac{1}{2 * π} * \sqrt{\frac{{k}_{1} + {k}_{2}}{{m}_{1} + {m}_{2}}} \qquad ( 2 )$$

where:
f_{ContactSolid}=frequency of oscillator upon contact with solid
k₁=effective spring constant of oscillator
k₂=effective spring constant of solid
m₁=effective mass of oscillator
m₂=effective oscillating mass of solid.

Except in the context of very compliant solids (such as certain food products), the effective oscillating mass of the solid is low; therefore, the ratio of k/m increases, which therefore results in an increase of the frequency of the ultrasonic stack upon contact with most solids. In the context of very compliant solids, the added spring constant is low, and the ratio of k/m decreases, which therefore results in a decrease of the frequency of the ultrasonic stack upon contact with such very compliant solids. In any event, the change in frequency is measurable and detectable. This change in frequency further is indicative of contact with a solid, whether very compliant or not.

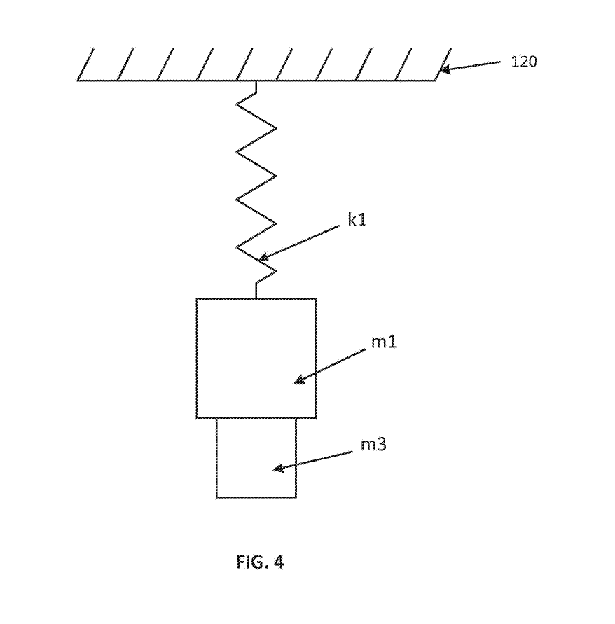

Similarly, a change in frequency can be detected when an ultrasonic stack makes contact with a liquid. Unlike in ultrasonic applications involving ultrasonic contact with a solid, liquids contacting oscillators (such as an oscillating ultrasonic stack) exhibit substantially no spring constant. Referring to FIG. 4, at least a portion of the mass of the liquid, however, ultrasonically oscillates upon contacting an oscillating ultrasonic stack. The frequency is determinable as follows:

$${f}_{ContactLiquid} = \frac{1}{2 * π} * \sqrt{\frac{{k}_{1}}{{m}_{1} + {m}_{3}}}$$

where:
f_{ContactLiquid}=frequency of oscillator upon contact with liquid
k₁=effective spring constant of solid
m₁=effective mass of oscillator
m₃=effective oscillating mass of liquid.

It should be noted that in ultrasonic applications with liquids substantially no spring constant is added. Nonetheless, the effective oscillating mass of the liquid for purposes of calculating the frequency is added to the effective mass of the oscillator, and accordingly the ratio of k/m decreases. The frequency of an ultrasonic stack therefore decreases upon contacting a liquid.

In every aforementioned case, whether the ultrasonic stack contacts a rigid solid, compliant solid, or liquid, the frequency of the ultrasonic stack changes at least because the ratio of k/m of the ultrasonic stack will not match the added ratio of k/m upon making contact with any of a rigid solid, compliant solid, or liquid. And because frequency is determined at least in part by the ratio of k/m, a change in frequency is determinative of contact in this context.

The frequency of the ultrasonic stack can be sensed electrically, e.g., by the controller, from the voltage or current being supplied to the ultrasonic stack by the power supply, or can be detected by a detector that senses the ultrasonic motion of the stack itself. Frequency can be sensed even in low power ultrasonics applications, as frequency dependence of contact is independent of power.

Detecting contact using a change of frequency according to the present disclosure offers several advantages. First, the location of the workpiece, anvil, or liquid can be ascertained, which can be helpful for future use. More specifically, but by way of non-limiting examples, when the location is known, the actuator can be slowed down before contact to prevent harming the object to be contacted or the ultrasonic stack, the actuator can be stopped at anvil contact to prevent harm to the ultrasonic stack, and/or the force of the actuator can be changed before contact with an object.

Second, the detection of contact can be helpful in real-time use. More specifically, but by way of nonlimiting examples, the actuator can change motion when workpiece or liquid contact is made, the ultrasonics can have its amplitude increased upon workpiece or liquid contact, the actuator can be stopped at anvil contact, the ultrasonics can be stopped at anvil contact, and/or the force of the actuator can be changed on workpiece, liquid, or anvil contact.

The detection of contact disclosed herein offers several benefits over the prior art. Unlike a force sensor that detects workpiece or anvil contact, only a very small contact force is necessary to detect contact through ultrasonic frequency change. And accordingly, for ultrasonic applications using small and/or delicate parts, contact can be detected without damaging the part. Further, for liquids, no force need be detected.

In accordance with an aspect of the present disclosure, a frequency of an ultrasonic stack not in contact with an object is measured and stored in a memory 116.

A change in frequency as the ultrasonic stack 102 and an object 126 (FIG. 1) are moved toward each other indicates that the ultrasonic stack 102 has contacted the object 126. Object 126 can be any of an anvil (such as anvil 122, liquid to be ultrasonically acted upon such as liquid 128 shown in phantom in FIG. 1 received on anvil 122 as also shown in phantom in FIG. 1, or a workpiece to be ultrasonically acted upon such as a part 122). Thus, the comparison of the measured frequency to a frequency previously measured is used to detect contact with an object. The frequency may be determined heuristically for ultrasonic stack 102 or theoretically.

In accordance with an aspect of the present disclosure, an initial frequency of the ultrasonic stack 102 is determined by power supply 104 under control of controller 112 which is a frequency at which ultrasonic stack 102 is oscillating near resonance in air. The determined initial frequency is illustratively stored in memory 116. In an aspect, controller 114 provides an alert that contact with object 126 has been made when a change in frequency of the ultrasonic stack 102 is sensed or measured. By way of example and not of limitation, the alert can be a visual indicator illuminated by controller 114, a message on a screen of a user interface, such as user interface 118 shown in phantom in FIG. 1, a message sent to a remote system monitoring ultrasonic device 100, or any combination of the foregoing.

It should be understood that neither the initial frequency of the ultrasonic stack nor any subsequent frequency of the ultrasonic stack need actually be calculated to determine that contact has been made. Rather, in such cases what is contemplated is that the initial frequency of the ultrasonic stack 102 is compared against subsequently determined frequencies of the ultrasonic stack 102 as ultrasonic stack 102 and object 126 are moved toward each other. When a subsequently determined frequency of the ultrasonic stack 102 deviates from the initial frequency of the ultrasonic stack 102, it is determined that ultrasonic stack 102 has made contact with object 126.

On the other hand, it is also contemplated that the initial frequency of the ultrasonic stack 102 may be calculated in some embodiments, e.g., by controller 114, where the calculated initial frequency of the ultrasonic stack 102 may be stored in memory 116. It is contemplated that a subsequent measurement or calculation would be used by controller 114 to determine a subsequent frequency of the ultrasonic stack 102, which would be then compared against the stored initial frequency of the ultrasonic stack 102. As discussed above, a change in the frequency correlates to ultrasonic stack 102 having made contact with object 126.

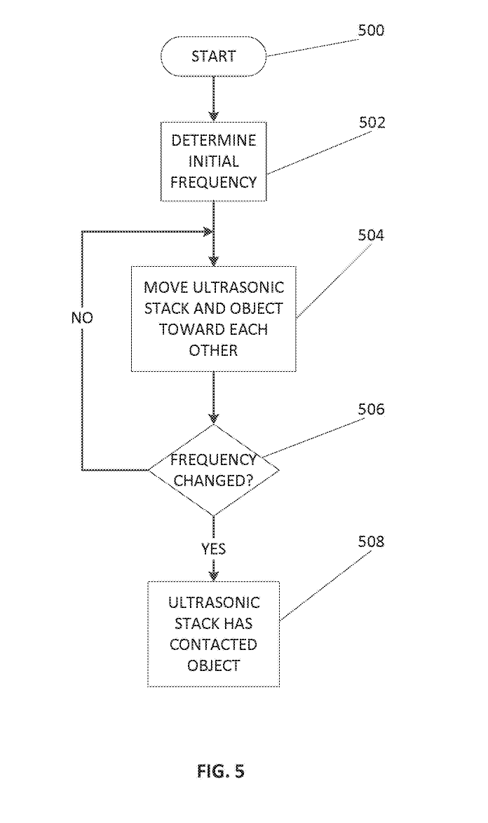

FIG. 5 is a flow chart of a control routine, illustratively implemented in controller 114, for the above described method of detecting when the ultrasonic stack of the ultrasonic device makes contact with an object. The control routine starts at 500. At 502, the initial frequency of the ultrasonic stack 102 is determined. To do so, the ultrasonic stack 102 is operated in air at near resonance and the frequency of the ultrasonic stack 102 oscillating at near resonance in air is determined and recorded as the initial frequency of ultrasonic stack 102. At 504, the ultrasonic stack 102 and object 126 are moved towards each other. In this regard, it should be understood that when it is said that ultrasonic stack 102 and object 126 are moved toward each other, this can include ultrasonic stack 102 being moved toward object 126, object 126 being moved toward ultrasonic stack 102, or ultrasonic stack 102 and object 126 both being moved toward each other. At 506, the control routine checks whether the frequency of the ultrasonic stack 102 has changed. If not, the control routine branches back to 504. If at 506 the control routine finds that the frequency of the ultrasonic stack 102 has changed, the control routine proceeds to 508 where it determines that the ultrasonic stack 102 has contacted the object 126. In this regard, when the frequency of the ultrasonic stack 102 is oscillating changes, this is indicative of the ultrasonic stack 102 making contact with the object 126.

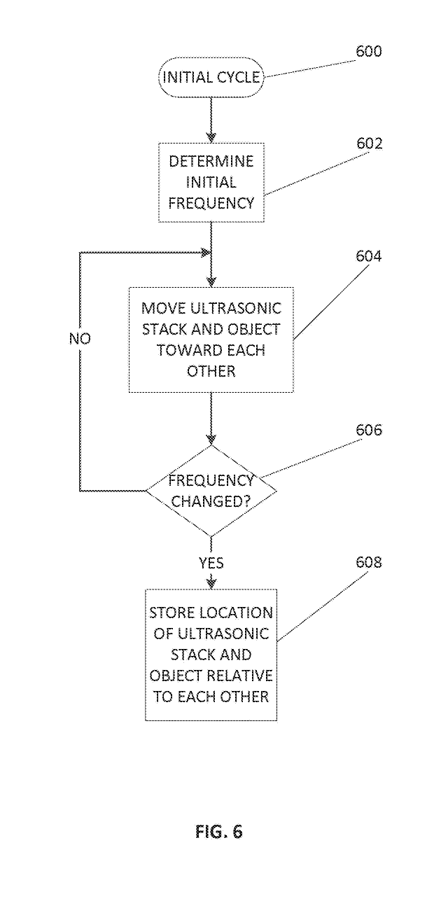

FIG. 6 is a flow chart of a control routine, illustratively implemented in controller 114, for the above described method of determining the location of object 126, such as an anvil, a workpiece, or liquid, for future use. The control routine starts at 600. At 602, an initial frequency of the ultrasonic stack 102 is determined as discussed above. At 604, the ultrasonic stack 102 and object 126 are moved towards each other. At 606, the control routine checks whether the frequency of the ultrasonic stack 102 has changed. If not, the control routine branches back to 604. If at 606 the control routine finds that the frequency of the ultrasonic stack 102 has changed, the control routine proceeds to 608 where a location of the ultrasonic stack 102 and object 126 relative to each other is saved. This location can then be used in subsequent ultrasonic cycles. As non-limiting examples, the speed at which the actuator moves ultrasonic stack 102 and object 126 toward each other can be altered, such as sped up, slowed down or stopped when it is known that contact between the ultrasonic stack 102 and an object 126, such as a workpiece (parts), anvils, and liquids, is imminent; ultrasonic power supplied to the ultrasonic stack 102 can be altered when contact with object 126 is imminent, such as ultrasonics being initiated when object contact by ultrasonic stack 102 is imminent for objects to be ultrasonically acted upon such as workpieces or liquids, or ultrasonics being stopped when object contact by ultrasonic stack 102 is imminent when the object is anvil 122 to stop the ultrasonics before ultrasonic stack 102 contacts anvil 122; and the force of the actuator can be changed before the ultrasonic stack 102 contacts object 126.

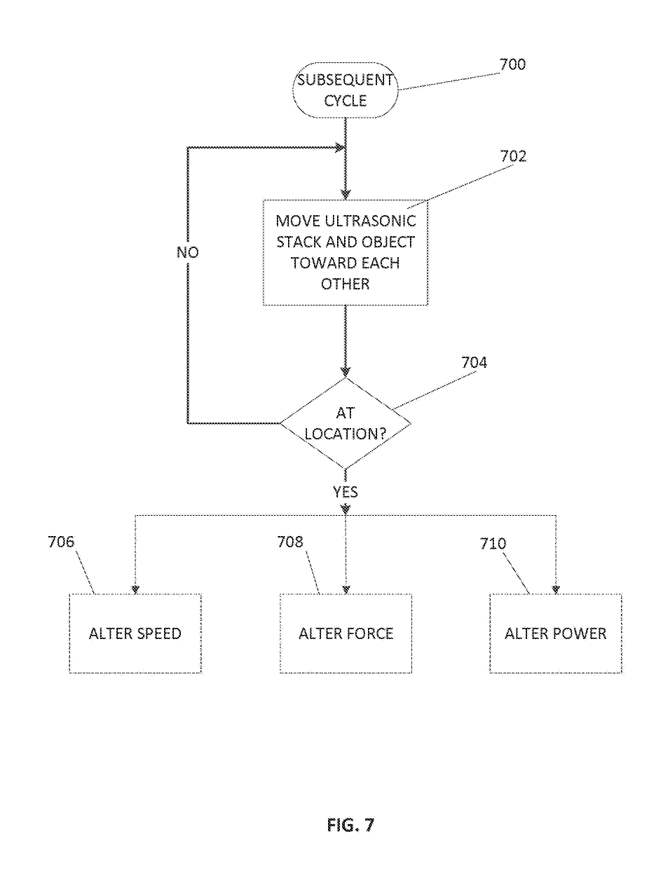

FIG. 7 is a flow chart of a control routine, illustratively implemented in controller 114, in which the location of the ultrasonic stack 102 relative to the object 126 is used in a subsequent ultrasonic cycle. The control routine starts at 700. At 702, the ultrasonic stack 102 and object 126 are moved toward each other. At 704, the control routine checks whether the ultrasonic stack and object 126 are at the saved location at which the frequency of the ultrasonic stack changed during the initial ultrasonic cycle. If not, the control routine branches back to 702. If so, the control routine proceeds to one of blocks 706, 708, 710 shown by dashed lines in FIG. 7 where it alters the speed at which the actuator is moving ultrasonic stack 102 and object 126 toward each other, alters the force at which the actuator is moving the ultrasonic stack 102 and object 126 toward each other, or alters the ultrasonic power being provided to ultrasonic stack 102.

It should be understood that when the actuator moves the ultrasonic stack 102 and object 126 toward each other, this can include the actuator moving the ultrasonic stack 102 toward the object 126, the actuator moving the object 126 toward the ultrasonic stack 102, or the actuator moving both the ultrasonic stack 102 and the object 126 toward each other.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. When it is stated that such a device performs a function, it should be understood that the device is configured to perform the function by appropriate logic, such as software, hardware, or a combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of detecting contact between an ultrasonic stack and an object wherein the object is any of an anvil, liquid to be ultrasonically acted upon and a workpiece to be ultrasonically acted upon, comprising:
moving with an actuator an ultrasonic stack ultrasonically vibrating near resonance and an object toward each other; and
determining that the ultrasonic stack has made contact with the object based on detecting a change in a frequency of the ultrasonic stack.

2. The method of claim 1, further comprising altering the speed at which the actuator is moving the ultrasonic stack and the object toward each other in response to detecting the change in frequency.

3. The method of claim 1, further comprising altering the ultrasonic power supplied to the ultrasonic stack in response to detecting the change in frequency.

4. The method of claim 1, further comprising altering the force at which the actuator is moving the ultrasonic stack and the object toward each other in response to detecting the change in frequency.

5. The method of claim 1, further comprising running an initial ultrasonic cycle wherein a location of the ultrasonic stack relative to the object at which the change in frequency was detected is stored in a memory of a controller.

6. The method of claim 5, further comprising running a subsequent ultrasonic cycle and altering a speed at which the actuator is moving the ultrasonic stack and object toward each other when a location of the ultrasonic stack relative to the object is at the location at which the change in frequency was detected in the initially run ultrasonic cycle.

7. The method of claim 5, further comprising running a subsequent ultrasonic cycle and altering ultrasonic power supplied to the ultrasonic stack when the location of the ultrasonic stack relative to the object is at the location at which the change in frequency was detected in the initially run ultrasonic cycle.

8. The method of claim 5, further comprising running a subsequent ultrasonic cycle and altering a force at which the actuator is moving the ultrasonic stack and object toward each other when the location of the ultrasonic stack relative to the object is at the location at which the change in frequency was detected in the initially run ultrasonic cycle.

9. An ultrasonic system, comprising:
an ultrasonic stack that delivers ultrasonic energy;
an actuator for moving the ultrasonic stack and an object toward each other;
a frequency detector for detecting a change in frequency of the ultrasonic stack wherein the change in frequency is indicative of the ultrasonic stack contacting the object;
a power supply in electrical communication with the actuator, the ultrasonic stack, and the frequency detector; and
a controller in electrical communication with the frequency detector, wherein the controller is configured to control the actuator.

10. The ultrasonic system of claim 9, wherein the object is any of an anvil, a liquid to be ultrasonically acted upon, or a workpiece to be ultrasonically acted upon.

11. The ultrasonic system of claim 10, wherein the controller is configured to alter the speed at which the actuator moves the ultrasonic stack and object toward each other in response to the frequency detector detecting the change in frequency.

12. The ultrasonic system of claim 10 wherein the controller is configured to control the power supply and the controller is configured to alter the power the power supply provides to the ultrasonic stack in response to the frequency detector detecting the change in frequency.

13. The ultrasonic system of claim 10 wherein the controller is configured to alter a force at which the actuator is moving the ultrasonic stack and object toward each other in response to the frequency detector detecting the change in frequency.

14. The ultrasonic system of claim 10, wherein the frequency detector is a detector that senses ultrasonic motion of the ultrasonic stack.

15. The ultrasonic system of claim 10 wherein the frequency detector is a detector that electrically senses frequency of voltage or current being provided to the ultrasonic stack by the power supply.
